(19) United States
(12) Patent Application Publication
(10) Pub. No.: US 2003/0063183 A1
(43) Pub. Date: Apr. 3, 2003

(54) Polygon mirror facet to facet intensity correction in raster output scanner

(75) Inventors: Vincent W. AuYeung, (US); Pancy Auyeung, Temple City, CA (US); Khuay Cam, Stanton, CA (US)

Correspondence Address: Patent Documentation Center, Xerox Corporation, Xerox Squate 20th Floor, 100 Clinton Ave. S., Rochester, NY, 14644, US

(73) Assignee: Xerox Corporation

(21) Appl. No.: 09/967,534

(22) Filed: Oct. 1, 2001

(51) Int. Cl. B41J 2/435

(52) U.S. Cl. 347/246

(57) ABSTRACT

An intensity correction circuit adjusts the intensity of the pixel data which modulates the light beam of a raster output scanner to compensate for facet to facet reflectivity intensity differences of the rotating polygon mirror used to scan the modulated light beam on a photosensitive medium.

### BACKGROUND OF THE INVENTION

The present invention relates to the facets of a rotating polygon mirror of a raster output scanner and, more particularly, to facet to facet intensity correction to provide uniform light exposure for scanning light beams reflected from the facets.

A raster output scanner incorporates a laser for generating a collimated beam of monochromatic radiation. The laser beam is modulated in conformance with the image information. The modulated beam is incident on a scanning element, typically a rotating polygon having mirrored facets. The light beam is reflected from each facet and thereafter focused to a spot on the photosensitive medium. The rotation of the polygon causes the spot to scan linearly across the photosensitive medium in a fast scan (i.e., line scan) direction. Each scan line crosses a start of scan (SOS) sensor and an end of scan (EOS) sensor, which regulates the image forming areas of the exposed image on the photosensitive medium.

Meanwhile, the photosensitive medium is advanced relatively more slowly in a slow scan direction which is orthogonal to the fast scan direction. In this way, the beam scans the medium with a plurality of scan lines in a raster scanning pattern. The light beam is intensity-modulated in accordance with input image information digital data, at a rate such that individual picture elements (“pixels”) of the image represented by the data are exposed on the photosensitive medium to form a latent image, which can then be developed and transferred to an appropriate image receiving medium such as paper.

In raster optical scanners, it is essential that the intensity of the scanning beam be accurately controlled at the scan line on the photosensitive medium. The beam reflected from the facets of the rotating polygon mirror must have a uniform intensity profile for precise imaging and scanning along the scan line and from scan line to scan line. This uniform intensity is important for gray scale printing, for example. The more uniform the intensity of the output power of the imaging beam, the more uniform the print pattern across the photosensitive medium will be.

The rotating polygon mirror of a raster output scanning system is typically formed of a reflective metal, such as aluminum. The aluminum substrate of the mirror is machined and polished to form flat reflective facets on the outside of the polygon.

Depending on the manufacturing tolerances, each facet might have different characteristics such as minute width, height, angle and reflectivity variations. Thus, as the light beam spots reflected from a sequence of facets on the polygon mirror move along the photosensitive image plane, these imperfections cause unintentional changes in the intensity of the resulting scan lines. This type of error is called facet to facet error.

The polygon mirror used in a raster output scanner has a typical facet to facet intensity difference of 2 percent with current machine polishing precision. As a result, most raster output scanners, at best, can achieve a 3 percent exposure uniformity difference.

The current method for raster output scanners to achieve less than 1 percent exposure uniformity difference is precision fabrication of the facets of the polygon mirror and precision alignment of the raster output scanner. This method is often unrepeatable from polygon mirror to polygon mirror and quite costly.

It is an object of this invention to provide an electronic means for facet to facet intensity correction of a rotating polygon mirror of a raster output scanner to provide uniform light exposure for scanning light beams reflected from the facets.

It is another object of this invention to provide an intensity difference of less than 1 percent from facet to facet of a rotating polygon mirror of a raster output scanner.

### SUMMARY OF THE INVENTION

According to the present invention, an intensity correction circuit adjusts the intensity of the pixel data which modulates the light beam of a raster output scanner to compensate for facet to facet reflectivity intensity differences of the rotating polygon mirror used to scan the modulated light beam on a photosensitive medium.

A power sensor, an analog-to-digital (A/D) converter and an inverter are used to determine the inverted intensity data, or intensity offset, for each facet. The intensity offset is stored in a suitable memory or look-up table in the intensity correction circuit to be applied to the pixel video data for that particular facet. The intensity offset will be applied to the modulation of the light beam to correct the facet to facet intensity differences.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a top view of a raster output scanner with electronic means for facet to facet intensity correction of the present invention.

FIG. 2 is a top view of the raster output scanner of FIG. 1 with a power sensor to determine facet to facet intensity variations.

FIGS. 3A, 3B and 3C are charts of the measured intensity profiles for facets of the raster output scanner of FIG. 1.

FIGS. 4A, 4B and 4C are charts of the inverted intensity offset profiles for the facets of FIGs. 3A, 3B and 3C of the present invention.

FIGS. 5A, 5B and 5C are charts of the inverted intensity corrected profiles for the facets of FIGS. 3A, 3B and 3C of the present invention.

### DESCRIPTION OF THE INVENTION

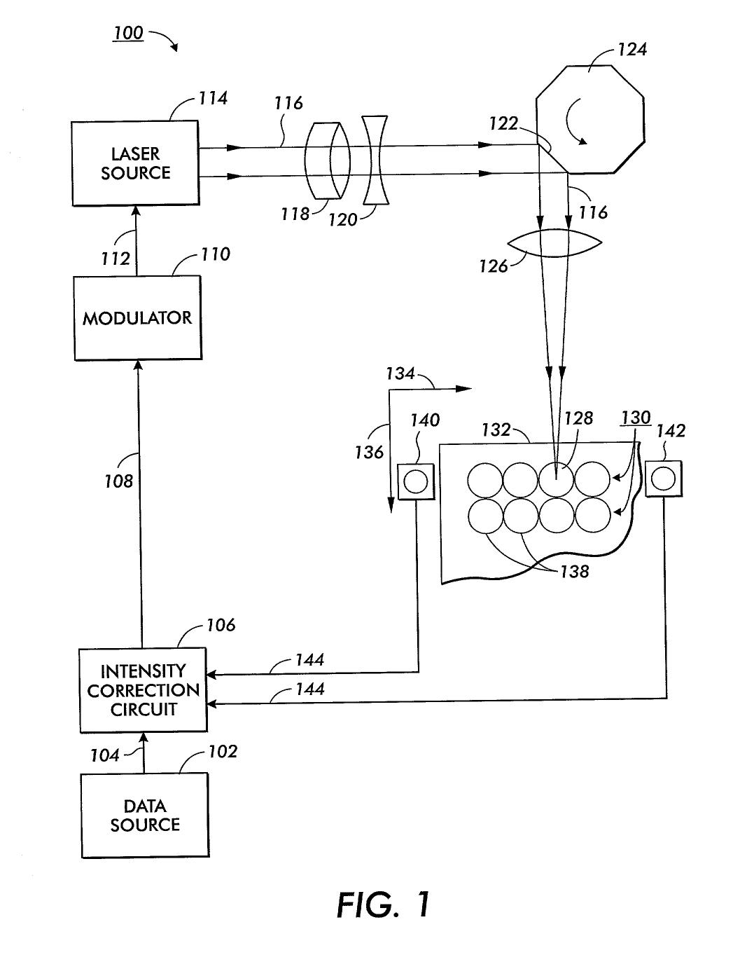

Reference is now made to FIG. 1, wherein there is illustrated the raster output scanner 100 with electronic means for facet to facet intensity correction of a rotating polygon mirror of a raster output scanner to provide uniform light exposure for scanning light beams reflected from the facets in accordance with this invention.

In the raster output scanner 100, the data source 102 sends pixel video data 104 to the intensity correction circuit 106 of the present invention. The intensity correction circuit 106 compensates and corrects the intensity of the pixel video data 104 to provide for uniform intensity exposure of the pixels. The intensity correction circuit 106 sends the intensity corrected pixel video data 108 to the modulator 110. The modulator 110 serially modulates the drive current 112 for the laser source 114 in accordance with the intensity corrected pixel video data 108. The pixel video data 104 may be for the printing of halftoned images and/or text and other types of line art, so the data source 102 generically represents any suitable source of raster data for intensity modulating the laser beam 116 on and off to form pixels.

The laser source 114 emits an intensity modulated laser beam 116 which is focused by a collimator lens 118 and the pre-polygon optics 120 onto one of the facets 122 of the rotating polygon mirror 124.

The facet 122 of the rotating polygon mirror 124 reflects the modulated light beam 116 which is focused by the post-polygon optics 126 to a generally circular spot 128 on the scan line 130 of the photosensitive medium 132.

The rotating facet 122 causes the spot 128 to sweep across the photosensitive medium 132 forming a succession of scan lines 130. The scan line 130 lies in what is commonly referred to as the fast scan direction, represented by arrow 134. In addition, as facet 122 is rotated, photosensitive medium 132 moves in a slow scan direction, substantially perpendicular to the fast scan direction, as represented by arrow 136. Movement in the slow scan direction is such that successive rotating facets 122 of the polygon 124 form successive scan lines 130 that are offset from each other in the slow scan direction 136. Each scan line 130 consists of a row of pixels 138, the pixels being produced by the modulation of the laser beam 116 as laser spot 128 scans across the photosensitive medium 132. As the beam scans across the scan line, spot 128 either illuminates, or does not illuminate, the individual pixel 138, in accordance with the pixel video signals 104.

The raster output scanner (ROS) system 100 has two sensors 140, 142 to detect the start of scan (SOS) and the end of scan (EOS). As the scanning laser light beam 116 passes over a dedicated spot on the scan line 130 immediately prior to pixel placement, the respective sensor 140 generates a start of scan SOS. In the same manner, as the scanning laser light beam 116 passes over a dedicated spot on the scan line 130 immediately after the end of pixel placement, the respective sensor 142 generates an end of scan EOS. The SOS and the EOS are being generated for each scan line 130, which corresponds to the reflection of the light beam from one of the plurality of facets of the rotating polygon mirror.

The optical elements in the raster output scanner 100, specifically the collimator lens 118, the pre-polygon optics 120 and the post-polygon optics 126, are all common to the modulated light beam 116 emitted by the laser source 114. Only the individual facets 122 of the rotating polygon mirror 124 are different for the modulated light beam. Accordingly, any differences in the intensities of the modulated beam at the photosensitive medium 132 are due to the individual facets and must be compensated.

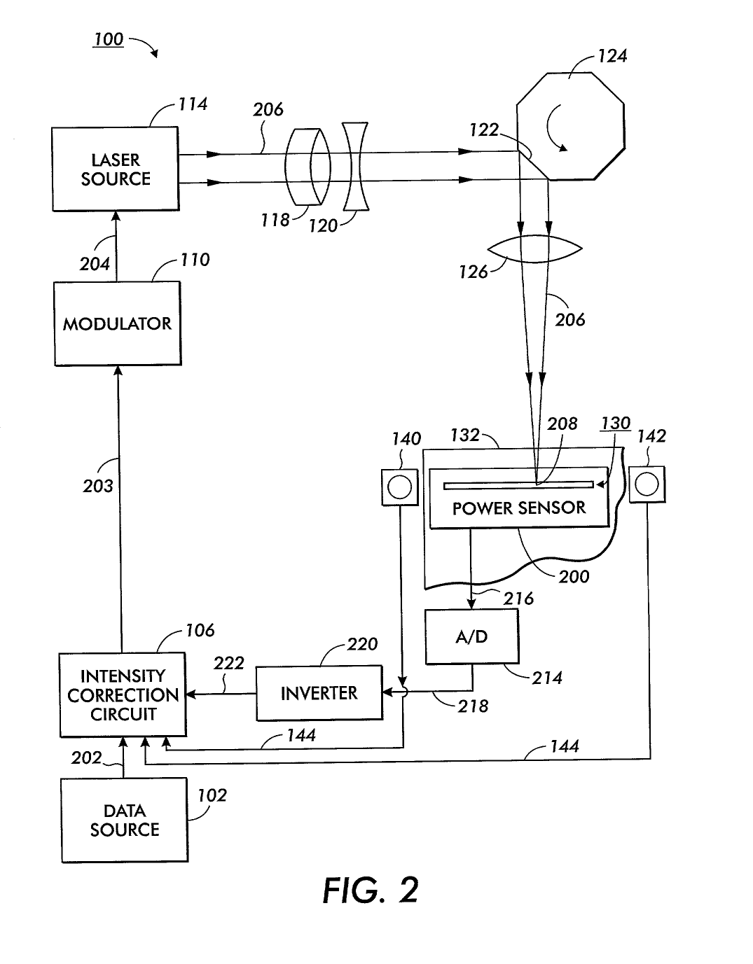

As shown in FIG. 2, after fabrication, assembly and alignment of the raster output scanner 100, but prior to operation of the scanner, a power sensor 200 is provided for quantitatively measuring the output intensities of each facet 122 of the rotating polygon mirror 124 of the ROS. The results of these intensity measurements are employed for producing intensity correction factors. It is desirable to equalize the output intensities of the facets of the polygon mirror of the ROS individually.

A solenoid actuated motor (not shown) can be coupled to the power sensor 200 for physically inserting it into and removing it from an optical sampling position between the facets 122 and the photosensitive medium 132 for making the intensity measurements. The power sensor will be physically positioned as close to the photosensitive medium 132 as possible and practical.

Alternatively, a beam splitter (not shown) could be used for diverting the light from the post-polygon optics 126 to the power sensor 200. Still another alternative is to provide a rotatable mirror (also not shown) for reflectively steering the light from the post-polygon optics 126 toward the power sensor 200 for intensity measurement.

The data source 102 will generate pixel video data 202 for a reference uniform intensity. The pixel video data 202 will not be changed by the intensity correction circuit 106. The pixel video data 202 will cause the modulator 110 to modulate the drive current 204 to the laser source 114.

The laser source 114 will emit a light beam 206 of a constant reference intensity. The light beam 206 will reflect off each facet 122 of the rotating polygon mirror 124 in sequence to be measured by the power sensor 200.

The power sensor 200 will measure the intensity of the reflected reference beam 206 pixel position 208 by pixel position across the entire scan line 130. Each scan line 130 corresponds to the reflectance of the reference beam 206 from one of the plurality of facets on the rotating polygon mirror. The SOS sensor 140 will mark the start of scan for a particular facet 122. The EOS sensor 142 will mark the end of scan for a particular facet 122.

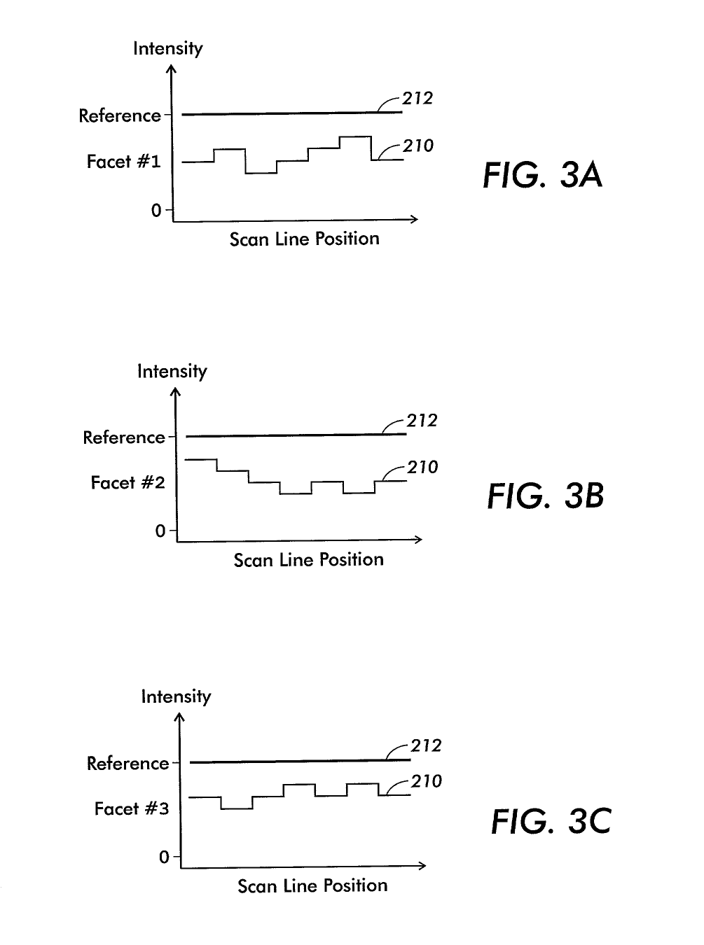

The power sensor 200 forms an exposure profile 210 of the intensities reflected from each facet relative to the constant reference intensity 212 in FIGS. 3A, 3B and 3C. As seen exaggerated in the Figures for ease of understanding, each pixel position 208 for the facet 122 will have a slightly different measured intensity (within a 3 percent intensity difference). Each facet relative to the other facets on the rotating polygon mirror will have a slightly different measured intensity profile 210.

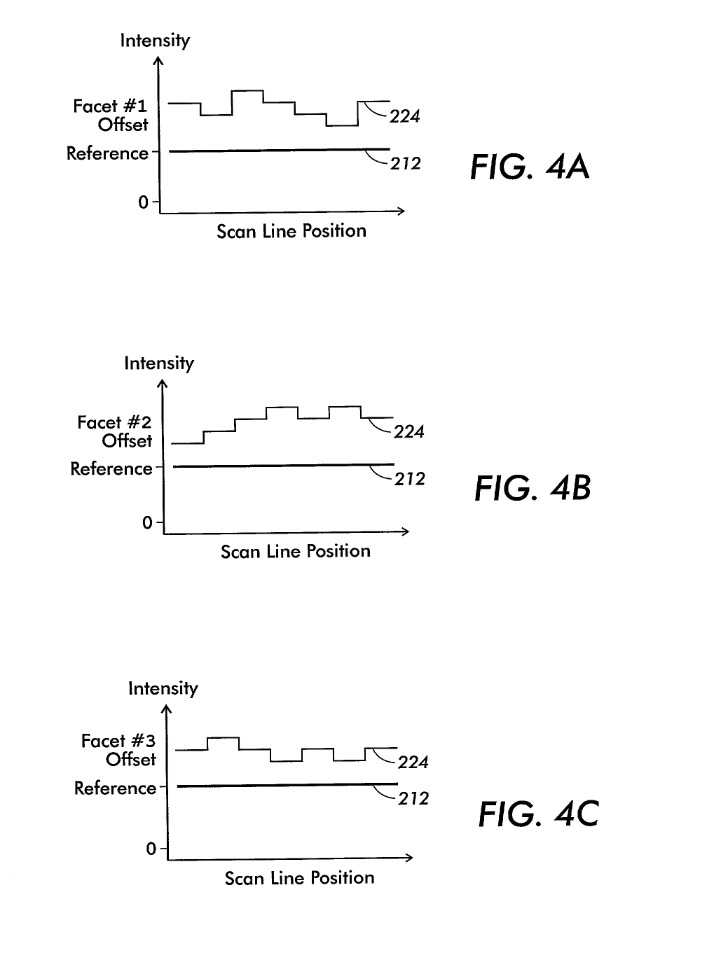

An analog-to-digital (A/D) converter 214 is coupled to the power sensor 200 for mapping the measured facet intensities 216 by pixel position for a particular facet 122 at the scan line 130 onto a predetermined scale of binary values. For example, the A/D converter 214 can employ standard 8-bit words for mapping the intensity measurements onto a binary scale having values ranging from 0 to 255. These binary intensity values 218, in turn, are applied to an invertor 220 which inverts the measured facet intensity values of the profile 210 in FIGS. 3A, 3B and 3C to form intensity inverted data 222 which is shown in the intensity profile 224 in FIGS. 4A, 4B and 4C.

The inverted intensity data 222, or intensity offset, for each facet 122 is stored at preselected addresses in a suitable memory or look-up table in the intensity correction circuit 106 to be applied to the pixel video data for that particular facet prior to the modulator to correct the facet to facet intensity differences when the raster output scanner is operating in its scanning mode.

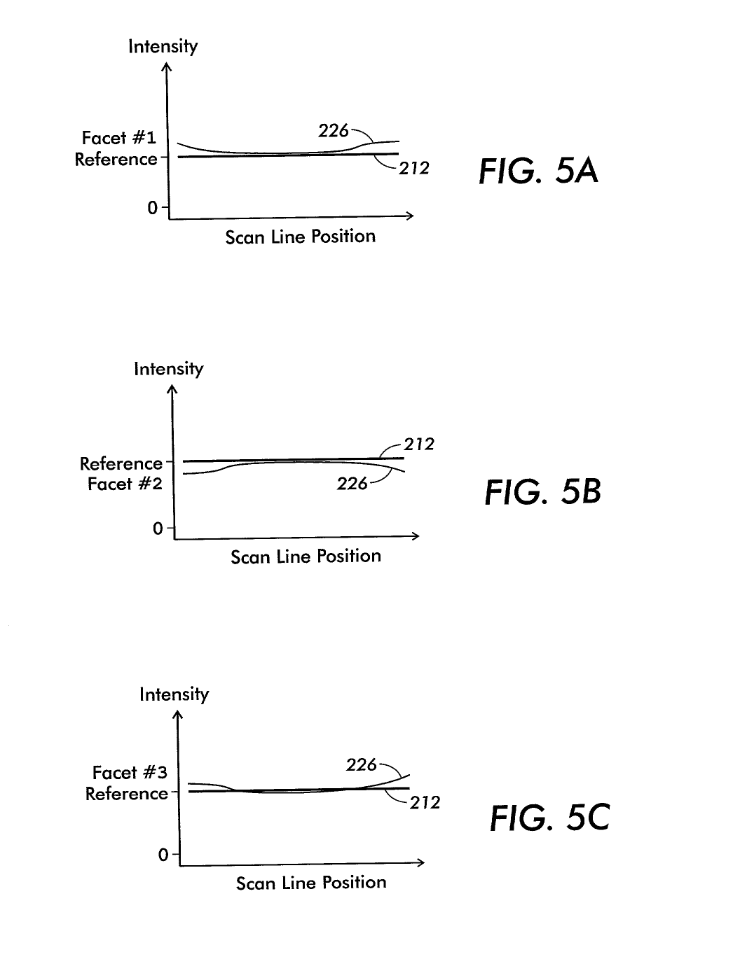

Combining the facet's intensity exposure profile with the intensity offset profile will create the intensity corrected profile 226 of FIGS. 5A, 5B and 5C. The intensity offset compensates and corrects the facet's intensity profile, as seen exaggerated in the FIGS. 5A, 5B and 5C for ease of understanding. Each pixel may be illuminated on or off but the illuminated pixels will have equal intensity reflected from the facet on the scan line with an intensity difference of less than 1 percent from facet to facet. Applying the intensity offset to the pixel video data compensates and corrects for any facet to facet intensity differences and helps ensure nearly uniform intensity at the photosensitive medium for the spots from the scanning light beam.

Returning to FIG. 1, during operation of the raster output scanner 100, the SOS sensor 140 and the EOS sensor 142 will continuously produce a signal 144 to the intensity correction circuit 106 indicative of the facet 122 from which the light beam 116 is being reflected.

The intensity correction circuit 106 will interpret the signal 144 to identify the current facet, or more appropriately, the next facet for the information modulated light beam 116 to be reflected from to the photosensitive medium 132.

The intensity correction circuit will access the memory or look up table for the appropriate intensity offset for that particular facet. The intensity offsets have been previously determined, characterized and stored.

The intensity correction circuit will apply the intensity offset for that particular facet to the pixel video data 104 from the data source 102 for that particular facet. The intensity correction circuit provides for uniform intensity exposure of the pixels. The intensity correction circuit 106 sends the intensity corrected pixel video data 108 to the modulator 110.

The intensity correction circuit operates in conjunction with the video data source and intensity correction circuit to produce signals that control the operation of laser to adjust the level or intensity of exposure on the photosensitive medium.

The first method for controlling the beam or spot intensity on the photosensitive medium is by actually adjusting the variation of the intensity of the beam. This may be accomplished by varying the power applied to the laser. Alternatively, the local exposure intensity may be controlled by altering the pulse width of the beam for each pixel position along the raster. In other words, by increasing/decreasing the exposure period for each pixel position in a laser scanning system responsive to pulse-width signals, the intensity of the beam on the photosensitive medium can be controlled.

Another benefit to the present invention is that the intensity offset for each facet helps smooth out the pixel to pixel intensity differences along a single scan line from a single facet.

The invention of the present application works with both flying spot and pulse imaging raster output scanning systems. More than one scanning light beam can be employed with the present invention.

While the invention has been described in conjunction with specific embodiments, it is evident to those skilled in the art that many alternatives, modifications and variations will be apparent in light of the foregoing description. Accordingly, the invention is intended to embrace all such alternatives, modifications and variations as fall within the spirit and scope of the appended claims.

What is claimed is:

1. A raster output scanning system comprising:
a light source for emitting a light beam;
a photosensitive medium;
a rotating polygon mirror having a plurality of reflective facets, said rotating polygon mirror being located in the path of said light beam from said light source to said photosensitive medium, each of said plurality of reflective facets scanning said light beam across said photosensitive medium;
means for providing pixel data;
means for modulating said light beam in accordance with said pixel data to form an image on said photosensitive medium; and
means for applying an intensity offset to said pixel data to correct for intensity differences of said plurality of reflective facets.

2. The raster output scanning system of claim 1 further comprising
a start of scan sensor and an end of scan sensor for generating a signal to said means for applying an intensity offset indicative of the specific facet scanning said light beam across said photosensitive medium.

3. The raster output scanning system of claim 1 wherein said intensity offset is determined by
said light source emitting a reference light beam;
a power sensor measuring the intensities of said reference beam reflected by each of said plurality of reflective facets at said photosensitive medium;
a converter for converting said intensities from said power sensor into intensity data for each of said plurality of facets; and
an inverter for inverting said intensity data, said inverted intensity data being said intensity offset in said means for applying an intensity offset.
